(19) United States
(12) Patent Application Publication
(10) Pub. No.: US 2014/0304888 A1
(43) Pub. Date: Oct. 16, 2014

(54) HEAD COVER

(71) Applicant: PHOENIX IT MANAGEMENT LLC, Burlington, NC (US)

(72) Inventor: De-Sheng TSAI, Burlington, NC (US)

(73) Assignee: Phoenix IT Management LLC, Burlington, NC (US)

(21) Appl. No.: 13/863,773

(22) Filed: Apr. 16, 2013

(51) Int. Cl. A62B 17/00

(52) U.S. Cl. CPC A62B 17/006
USPC 2/173

(57) ABSTRACT

An expandable head cover is made in one-piece flat form of width 9-15″ and made of two latex-free nonwoven sheets of having a retraction force of greater than 0.5 lb/2″ and less than 3 lb/2″ from a 100% elongation and a hydrostatic pressure resistance of above 500 mm H₂O/100 cm². The head cover has at least one eye opening covered with a transparent film.

### BACKGROUND OF THE INVENTION

1. Field of the Invention

This invention is related to a head cover, and more particularly, to a head cover used as a protective hood by workers in shield against liquid splashes and chemical or paint spray.

2. Description of Related Art

The types of respirators attached with protruded air filters or a full-face shield connected with air-fed pumping system are popular in the work places for respiratory protection. Nonetheless, both conventional respirator and the full-face shield system do not provide protective coverage on wearer's scalp and neck. The coverall hood and cotton spray sock have been commonly used for supplementing the head covering purpose. However, the coverall hood leaves the wearer's neck exposed. Its stiffness restricts the wearer's head movement and slows down work efficiency. The spray sock made from knitted fabric has big openings in its stretched form which allows debris and spray drips to penetrate therethrough.

Other types of head cover include a rigid upside-down bucket shape as shown in, such as, U.S. Pat. Nos. 8,225,428; 8,201,273; 6,691,134 or 5,226,409 or as a soft bag as shown in, such as, U.S. Pat. Nos. 8,316,844; 8,011,023; 7,415,981; 6,997,179; 6,907,878; 6,782,556; 6,340,024; or 5,133,344. To accommodate different size of wearers' heads, these covers are made much larger than the head size. They rely on external straps for fastening or an internal suspension system to be worn. They are constructed with sections of materials and manufactured in multiple steps. The problems with these head covers are that they are bulky, do not fit will to the wearer, and are tedious to manufacture.

U.S. Pat. No. 4,870,959 and U.S. Pat. No. 5,625,902 describe elastic head covers made by dipping a head mold into elastomeric solutions of butyl rubber or neoprene. However, the butyl rubber and plasticizer used in making the elastic hood can cause allergic reaction and irritation when it contacts with the wearer's skin.

### SUMMARY OF THE INVENTION

The primary objective of the present invention is to provide a head cover made from latex-free elastic nonwoven fabric. It is made in one-piece flat form by continuous thermal forming process including sheet layering, sheet bonding, and seam sealing followed by a rotary die-cutting. There are build-in air channels in the head cover for air venting or air intake. The head cover of the present invention may be used by workers to shield against liquid splashes and chemical or paint over spray.

It is an objective of this invention to provide a new and improved protective hood for covering the entire head and neck to shield against liquid splashes and chemical or paint overspray.

It is another objective of this invention to provide a new and improved protective hood made of latex-free elastic nonwoven sheets to enable conformed fit on the wearer's contour.

It is another objective of this invention to provide a new protective hood to be made in one-piece flat form by a continuous process.

Still another objective of the invention is to provide a new and improved protective hood being able to be connected with an air-fed system.

### BRIEF DESCRIPTION OF THE DRAWINGS

The preferred embodiment(s) of the invention, as well as its many advantages, may be further understood by the following detailed description and accompanying drawings.

FIG. 1 is a side view of the head cover of the preferred embodiment of the present invention;

FIG. 2 is a perspective view showing the overall appearance of the head cover of the preferred embodiment of the present invention; and

FIG. 3 is still a side view of the head cover of the preferred embodiment of the present invention.

### DETAILED DESCRIPTION OF THE INVENTION

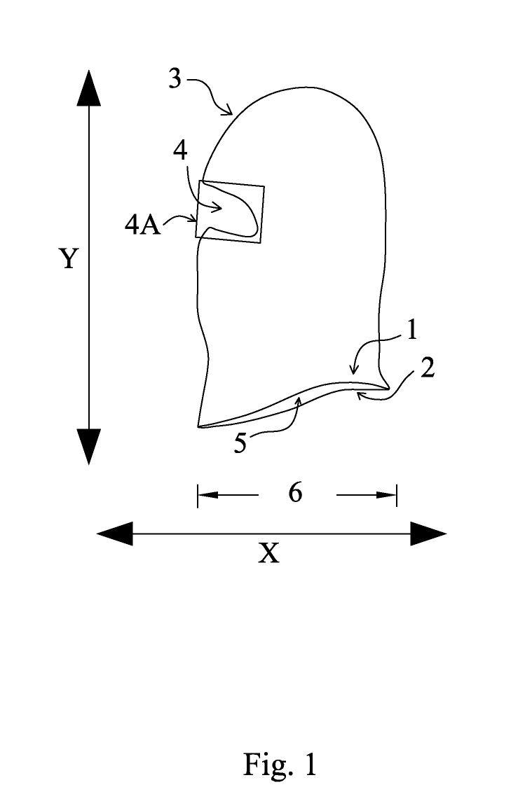

The present invention provides a low-cost article that can be used as a protective head cover, which is made in one-piece flat form, continuously by a thermal-forming process, utilizing latex-free elastic nonwoven sheets to achieve comfortable fit to the wearer. As shown in FIG. 1, the flat form of the hood when it is made. The hood is designed to be continuously made in one piece of flat form by thermal-forming process including sheet layering, sheet-bonding, and seam sealing followed by rotary die-cutting process in the machine direction (Y). The seam line 3 aligns with the center line of wearer's head. The eye slot 4 can be one opening as shown or two holes (not shown), one on upper sheet and the other on the under sheet. The eye opening is covered with transparent film 4A.

The upper sheet 1 and lower sheet 2 are the same material selected from latex-free elastic nonwoven web described in patents U.S. No. 7,713,894 and EP 1974080 or elastic laminates described in U.S. Pat. No. 8,123,890. The sheet can be a single layer or multiple layers bonded with polymeric film or membrane such as PE, PP or elastomers, to have hydrostatic pressure resistance of above 500 mm H₂O/100 cm² for effectively blocking liquid splashes.

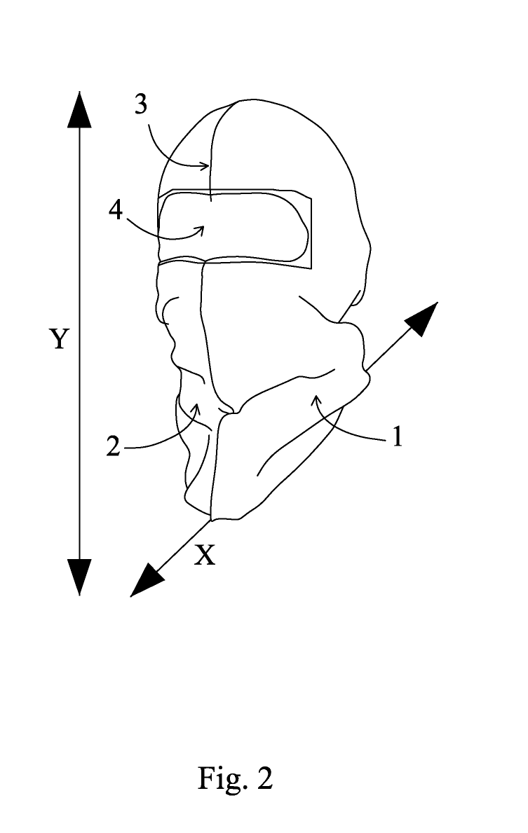

The design and engineering of hood size and retraction force of this invention achieves an expandable hood with one-size-fits-all conformability and comfortable fit to the wearer. The sheets are engineered to have cross-directional (X) elasticity with a retraction force of more than 0.5 lb/2″ in a 100% elongation. The width of the hood 6 is designed to be 9-15″ to make the opening 5 of 18-30″ for accommodating all adult head sizes. The retraction force of above 0.5 lb/2″ at the conformed area enables the hood to hold snugly on the wearer's head. The retraction force of under 3 lb/2″ on the conformed area is to prevent over-tightness and localized stress t to the wearer. FIG. 2 shows the expanded form of the hood of the preferred embodiment of the present invention.

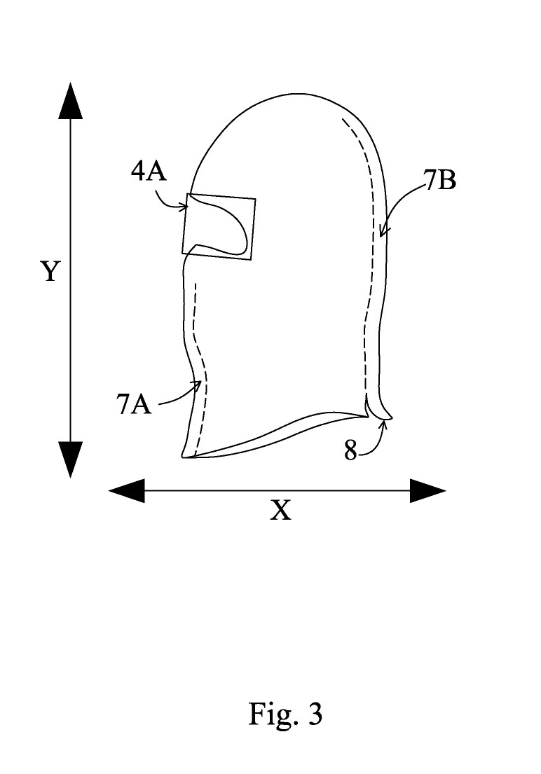

FIG. 3 shows the hood with internal air-channel design. Air channel 7A can vent the breath air and prevent fogging of the eye film shield 4A. An extended tube structure 8 from air-channel 7B is for air pipe insertion from air-fed system. The air-permeability of the sheet is engineered to be less than 10 in³/in²/min to retain air from a commercial air-fed system with 4-10 cubic ft/min capacity. The pressured air connected into the hood can supply the filtered air to the wearer and the positive pressure prevents the entrance of ambient air from surrounding work environment.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An expandable head cover in one-piece flat form of width 9-15″ and made of two latex-free nonwoven sheets of having a retraction force of greater than 0.5 lb/2″ and less than 3 lb/2″ from a 100% elongation and a hydrostatic pressure resistance of above 500 mm H₂O/100 cm², the head cover having at least one eye opening covered with a transparent film.

2. The expandable head cover as claimed in claim 1 further comprising at least one air channel for breath air venting.

3. The expandable head cover as claimed in claim 1 further comprising at least one built-in air channel for breath air venting.

4. The expandable head cover as claimed in claim 1 further comprising a separated extension structure for air tube insertion.

5. The expandable head cover as claimed in claim 4, wherein at least one air channel for breath air venting is provided.

6. The expandable head cover as claimed in claim 4, wherein at least one built-in air channel for breath air venting is provided.

7. An expandable head cover in one-piece flat form of width 9-15″ and made of two latex-free nonwoven sheets of having a retraction force of greater than 0.5 lb/2″ and less than 3 lb/2″ from a 100% elongation and an air permeability of less than 10 in³/in²/min, the hydrostatic pressure resistance of above 500 mm H2O/100 cm², the head cover having at least one eye opening covered with a transparent film.

8. The expandable head cover as claimed in claim 7 further comprising at least one air channel for breath air venting.

9. The expandable head cover as claimed in claim 7 further comprising at least one built-in air channel for breath air venting.

10. The expandable head cover as claimed in claim 7 further comprising a separated extension structure for air tube insertion.

11. The expandable head cover as claimed in claim 10, wherein at least one air channel for breath air venting is provided.

12. The expandable head cover as claimed in claim 10, wherein at least one built-in air channel for breath air venting is provided.
